(19) United States
(12) Patent Application Publication
(10) Pub. No.: US 2010/0084986 A1
(43) Pub. Date: Apr. 8, 2010

(54) CIRCUIT ARRANGEMENT AND METHOD FOR PROGRESSIVELY DIMMING ONE OR MORE LIGHTING MEANS

(75) Inventors: Werner Longhino, Mehring (DE); Thomas Mudra, Kastl (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/530,238

(22) PCT Filed: Mar. 9, 2007
(86) PCT No.: PCT/EP2007/052223

§ 371 Date: Sep. 8, 2009

(51) Int. Cl. H05B 37/02

(52) U.S. Cl. 315/224

(57) ABSTRACT

Various embodiments provide a circuit arrangement with two or more switching inputs for progressively dimming one or more lighting means, the switching inputs being capable of being current-conducting or non-current-conducting, wherein the circuit arrangement is configured such that it, owing to the switching combination of the switching inputs, provides a dimming signal at the output, which dimming signal can be processed by the operating devices connected thereto and dims the lighting means to corresponding light levels.

### TECHNICAL FIELD

The invention relates to an electronic module which drives electronic operating devices for lighting means which are suitable for dimming these lighting means.

### PRIOR ART

There are a wide variety of possible solutions for dimming lighting means in lighting installations. Firstly, for relatively large lighting installations there has already been for a very long time an analog interface which reproduces the respective dimming state via an analog voltage of from 1 to 10 V. Secondly, there is a more recent digital interface, with which a wide variety of complex lighting tasks can be resolved. Both methods have the disadvantage in common that a control bus is required for this purpose, and this control bus was not provided in earlier installations.

Earlier installations often use the so-called three-stage dimming, which has primarily found use in the NAFTA sector. In this case, two electronic operating devices are used in a luminaire. Generally, the first operating device controls a lighting means, and the second operating device controls two lighting means. The lighting means all have the same power. The luminaire is driven using two phases. Depending on which phase is connected, three dimming levels can be realized, with the operating devices either being driven individually or jointly. If only the first operating device is operated, one lighting means illuminates. If only the second operating device is operated, 2 lighting means illuminate. If both are operated, all 3 lighting means illuminate. Three “dimming levels” can therefore be realized, in the present example at approximately 33%, 66% and 100% in the case of lighting means of the same power. Since this variant is very cost-intensive and, in the case of modernizations, luminaires with fewer than 3 lighting means are often used, there is the problem of the continued use of the existing installation with two or more switched phases and modern luminaires.

### OBJECT

The object of the invention is therefore to specify a circuit arrangement which makes it possible to be able to use an installation with a plurality of switched phases which can represent different dimming settings with modern dimmable operating devices.

### DESCRIPTION OF THE INVENTION

The object is achieved by a circuit arrangement having the features of patent claim 1 and by a method having the features of patent claim 8.

### BRIEF DESCRIPTION OF THE DRAWING(S)

FIG. 1: Schematic illustration of the circuit arrangement.

FIG. 2: Different circuitry variants of the circuit arrangement.

FIG. 3: Schematic illustration of a lighting installation with dimmable operating devices

### PREFERRED EMBODIMENT OF THE INVENTION

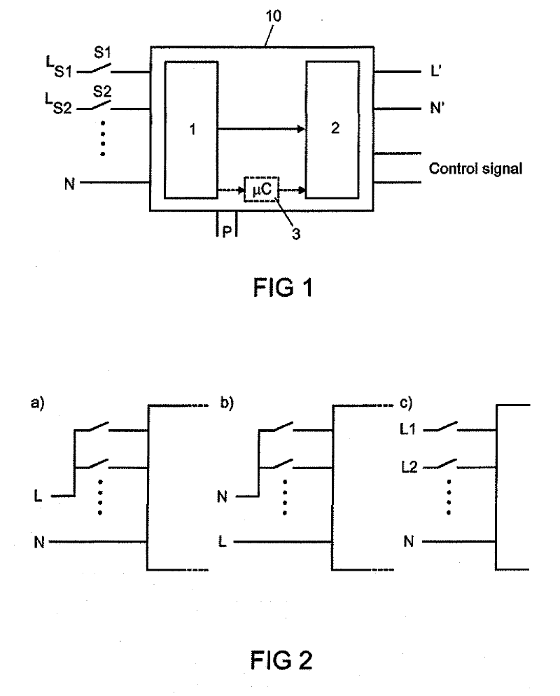

FIG. 1 shows a schematic illustration of the circuit arrangement 10 according to the invention. The arrangement contains an input part 1 with a decoder, an output part 2 and preferably also a processor part 3. The decoder part 1 decodes the combination of switching signals present and assigns them to corresponding dimming settings. These dimming settings are either assigned directly to permanently programmed light levels or input into the controller part 3, which outputs the stored values of the light levels for the corresponding dimming settings. The output part 2 converts the light levels into a control signal which can be used by the operating device and outputs this control signal to the operating device or devices.

The control signal can in this case be a digital signal, for example a DALI signal, but it may also be an analog signal, for example for the 1.10V interface. In the case of the preferred programmable circuit arrangement, the desired protocol can also be selected during programming.

Depending on how many inputs the circuit arrangement has, a corresponding number of dimming levels is possible. In principle 3 dimming levels are possible with 2 switching inputs, 7 dimming levels with 3 switching inputs etc. In general it can be said that 2ⁿ−1 dimming levels are possible with n switching inputs.

By way of example a few dimming tables are provided:

The dimming table for two dimming levels is as follows:

| | | Dimming level |
|---|---|---|
| Switching input L_{S1} | Switching input L_{S2} | lighting means |
| Off | Off | Off |
| On | Off | Light value 1 |
| | | (e.g. 50% light) |
| Off | On | Light value 1 |
| | | (e.g. 50% light) |
| On | On | Light value 2 |
| | | (e.g. 100% light) |

If only in each case one switching input is current-conducting, a first light value is output at the output of the operating device. This light value can be freely programmable or permanently provided, depending on the embodiment. If both switching inputs are switched so as to be current-conducting, a second light value is output. This light value can likewise be freely programmable or permanently set (for example 100%).

However, a three-stage dimming is also possible with two switching inputs. The dimming table for this may be as follows:

| | | Dimming level |
|---|---|---|
| Switching input L_{S1} | Switching input L_{S2} | lighting means |
| Off | Off | Off |
| On | Off | Light value 1 |
| | | (e.g. 25% light) |
| On | On | Light value 3 |
| | | (e.g. 50% light) |
| Off | On | Light value 2 |
| | | (e.g. 100% light) |

This embodiment has the advantage that, for a change in the light value, it is not necessary for a switching input to be switched on while the other is switched off simultaneously. The problem of the current being interrupted during switchover is thereby circumvented.

In the case of three-stage dimming, there is also a third light value, since a distinction is drawn between the two switching inputs. If switching input 1 is current-conducting and switching input 2 is not, a different dimming value is set than if switching input 2 is current-conducting and switching input 1 is not.

FIG. 2 shows some possible circuit configurations of the switching inputs: FIG. 2a connects one phase to both inputs. In FIG. 2b, the phase and neutral conductor are swapped over, and both inputs are connected to the neutral conductor. In FIG. 2c, finally, two different phases are connected to the two inputs.

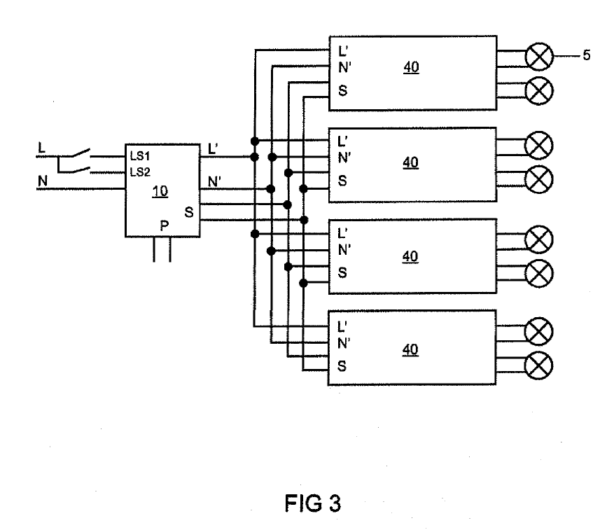

FIG. 3 shows a schematic arrangement of a lighting installation with dimmable two-lamp operating devices. It is clear that even large lighting installations can be controlled and dimmed effectively and easily with such an arrangement. The interface S can in this case be an analog or a digital interface.

The operating devices do not necessarily need to be supplied with current from the circuit arrangement. It is also possible for the circuit arrangement only to output a dimming signal and for the current supply for the operating devices to take place autonomously, and not via the circuit arrangement.

The light values assigned to the dimming levels can preferably be programmed. In order to be able to program the light values into the circuit arrangement, different variants are used:

for example rotary regulators, for example trimmers or potentiometers, can be provided at the housing, via which rotary regulators the respective light levels can be set. However, it is also possible for step switches, for example DIP switches, to be used in order to be able to select from a plurality of dimming levels.

However, it is also possible for an interface P to be provided, to which an external programming device can be connected in order to program the various light levels. In this case, different data transmission types are conceivable:
The circuit arrangement can have an infrared reception module, via which the different dimming levels can be programmed into the circuit arrangement.
A further option is for the circuit arrangement to have a reception module for electromagnetic radiation and for the dimming levels to be programmed via the reception of a specific signal sequence.
Finally, it is also conceivable for the circuit arrangement to have a module for extracting a signal sequence on the switching inputs LS1 or LS2 or the terminal L. This signal sequence is modulated onto the lines and processed by the circuit arrangement in order to program the dimming levels.

1. A circuit arrangement, comprising: two or more switching inputs for progressively dimming one or more lighting means, the switching inputs being capable of being current-conducting or non-current-conducting, wherein the circuit arrangement is configured such that it, owing to the switching combination of the switching inputs, provides a dimming signal at the output, which dimming signal can be processed by the operating devices connected thereto and dims the lighting means to corresponding light levels.

2. The circuit arrangement as claimed in claim 1, wherein the light levels of the respective switching combinations are permanently programmed.

3. The circuit arrangement as claimed in claim 1, wherein the light levels of the respective switching combinations can be freely programmed.

4. The circuit arrangement as claimed in claim 3, wherein the circuit arrangement comprises at least one component of the group of components configured to set freely selectable light levels; rotary regulators; multistage switches; and a plurality of switches.

5. The circuit arrangement as claimed in claim 3, further comprising: a further interface configured to provide the programming.

6. The circuit arrangement as claimed in claim 5, wherein the further interface is an interface selected from a group of interfaces consisting of: a line interface; an infrared interface; and an interface for electromagnetic radiation.

7. The circuit arrangement as claimed in claim 3, further comprising: a modulator configured to modulate a signal sequence onto the lines of the switching inputs to program the freely selectable light levels.

8. A method for progressively dimming one or more lighting means, the method comprising: converting switching combinations of two or more inputs of a circuit arrangement into dimming levels; assigning the dimming levels light values; converting the light values into a dimming signal; outputting the dimming signal at the output of the circuit arrangement in order to set operating devices, into which the dimming signal is in turn input, to a dimming state in order to dim the lighting means connected to the operating devices.
